(19) United States
(12) Patent Application Publication
(10) Pub. No.: US 2007/0053065 A1
(43) Pub. Date: Mar. 8, 2007

(54) Diffusion sheet

(75) Inventor: Kimitoshi Nagao, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/514,955

(22) Filed: Sep. 5, 2006

(30) Foreign Application Priority Data
Sep. 5, 2005 (JP) P2005-256477

(51) Int. Cl. G02B 5/02

(52) U.S. Cl. 359/599; 359/831

(57) ABSTRACT

A diffusion sheet interposed between a light guide plate and a prism sheet includes: a light reflection unit reflecting a feedback light toward the prism sheet again, the feedback light being returned by the prism sheet.

### BACKGROUND OF THE INVENTION

1. Field of the Invention

The present invention relates to a diffusion sheet for use in a display device of a flat-type TV, a cellular telephone, a digital camera, a car navigation system, a desktop PC, a mobile PC, a PDA, a cash dispenser, and the like.

2. Background Art

In a display device, such as a liquid-crystal display device, brightness is improved by means of enhancing utilization efficiency of light. To this end, a diffusion sheet is placed on a light guide plate of a backlight unit, and one to two sheets of gable-like prisms are additionally placed on the diffusion sheet. The prisms on the surface of the prism sheet gather light within a plane orthogonal to a crest of each of the prisms. In the backlight unit using the prism sheets, the light guide plate is stacked on the diffusion sheet and a reflection sheet, and another prism sheet is provided at a light exit side of the diffusion sheet. The backlight is housed in a backlight unit case.

Light emitted from a CCFL, an LED, or the like, which is the light source, or light reflected by a reflector enters the light guide plate made of transparent resin. The light having entered the light entrance end face of the light guide plate propagates through a medium; namely, the light guide plate. A portion of the light enters the prism sheet after having passed through the diffusion sheet. The light undergoes refraction and reflection in the prisms; exits in a converged state; and then enters a liquid-crystal panel or the like. The light reflected by the reflection sheet also enters the light guide plate. In the same manner as mentioned above, the light passes through the diffusion sheet; undergoes refraction and reflection on the prism sheet; exits in a converged state; and enters a liquid-crystal panel and the like. In the liquid-crystal panel, the light having exited from the prism sheet is displayed on each of pixels as backlight.

However, when the light reflected by prism lenses of the prism sheet has returned to the surface of the diffusion sheet, the light undergoes diffusion and reflection at an upper surface of the diffusion sheet (the surface of the diffusion sheet facing the prism sheet). The diffusion sheet is usually designed for the purpose of diffusing or converging the light having exited from the light guide plate. Therefore, the reflection characteristic of the diffusion sheet is determined as a consequence of design. Specifically, the light returning toward the diffusion sheet and the light guide plate upon reflection by the prism lenses, in its present form, is absorbed or becomes stray light, to thus become useless and result in decreased utilization efficiency of light. From the viewpoint of an improvement in brightness, which is the purpose of use of the prism sheet, a decrease in utilization efficiency of light is not preferable, and results in unevenness or a decrease in forward brightness.

### SUMMARY OF THE INVENTION

The present invention has been conceived in view of the above circumstances, and an object of the present invention is to provide a diffusion sheet capable of efficiently reflecting feedback light when the light has returned from the prism sheet to thus return the light toward the prism sheet, thereby attempting to enhance the utilization efficiency of light and achieve uniform and enhanced forward brightness.

The above object of the present invention is achieved by the following configurations:
(1) A diffusion sheet interposed between a light guide plate and a prism sheet, including: a light reflection unit reflecting a feedback light toward the prism sheet again, the feedback light being returned by the prism sheet.

By means of this sheet, the feedback light, from the prism sheet, which has hitherto been absorbed or become stray light is again returned toward (is caused to re-enter) the prism sheet by means of reflecting action of the light reflection unit. A loss of the feedback light resulting from provision of the prism sheet is diminished.
(2) The diffusion sheet as described in the item (1), wherein the light reflection unit includes: a translucent substrate; and a fine projection section arranged on a surface of the translucent substrate opposite the prism sheet, the fine projection section having a conical shape.

In this diffusion sheet, the feedback light having entered the translucent substrate by way of the prism sheet side thereof propagates through the inside of the translucent substrate, whereupon the direction of the light is inverted by two nonparallel slopes of a pyramidal minute projection section formed on the side of the translucent substrate opposite the prism sheet. The light then travels as if it returned toward the entrance, and is again emitted toward the prism sheet from the entrance side of the translucent substrate where the light has first entered.
(3) The diffusion sheet as described in the item (2), wherein the fine projection section is regularly arranged at equal intervals in lateral and longitudinal directions.

In this diffusion sheet, as a result of the minute projection sections being regularly arranged, the action of the minute projection sections for reflecting the feedback light can comply with the respective pixels of, e.g., a display device. Effective improvements in an image, such as an increase in the brightness of the principal section (i.e., each of the pixel sections), and the like, can be achieved.
(4) The diffusion sheet as described in the item (2), wherein the fine projection section is irregularly arranged at indefinite intervals and directions.

In this diffusion sheet, the fine projection sections are irregularly arranged, and hence the pixels of the display device and the minute projection sections oppose each other at irregular relative positions, thereby preventing occurrence of moire, which would otherwise be caused when the pixels and the respective minute projection sections are cyclically arranged so as to oppose each other.
(5) The diffusion sheet as described in the item (2), wherein the light reflection unit includes: a pad layer having an irregular structure formed on a surface of the translucent substrate and diffusing light; and a light transmissive reflection layer formed along the irregular structure of the pad layer and containing light diffusion-and-reflection fine particles.

In the diffusion sheet having such a structure, the incident light from the light source, which exits from the pad layer of the irregular structure, is diffused and enters the prism sheet. The feedback light from the prism sheet undergoes reflection on the light diffusion-and-reflection fine particles of the light transmissive reflection layer provided on the surface of the pad layer, and again exits toward the prism sheet.
(6) The diffusion sheet as described in the item (2), wherein the light reflection unit includes: a light-gathering layer formed on a surface of the translucent substrate and including transparent fine particles collecting a transmitted light; and a light transmissive reflection layer formed on a light exit surface of the light-gathering layer and containing light diffusion-and-reflection fine particles.

In this diffusion sheet, the incident light from the light source, which passes through the light-gathering layer, is collected by the transparent fine particles, and exits toward the prism sheet. Further, the feedback light from the prism sheet undergoes reflection on the light diffusion-and-reflection fine particles of the light transmissive reflection layer provided on the surface of the light-gathering layer, and again exits toward the prism sheet.

The diffusion sheet of the present invention has the light reflection unit for again reflecting feedback light, which has been returned upon reflection by the prism sheet, toward the prism sheet. Accordingly, the feedback light, from the prism sheet, which has hitherto been absorbed or become stray light is again returned toward (is caused to re-enter) the prism sheet by means of reflecting action of the light reflection unit. A loss of the feedback light resulting from provision of the prism sheet is diminished, and the utilization efficiency of light can be enhanced. Consequently, front brightness can be made uniform and enhanced.

### BRIEF DESCRIPTION OF THE DRAWINGS

The invention disclosed herein will be understood better with reference to the following drawings of which:

FIG. 1 is a side view that illustrates a characteristic portion of a backlight unit having a diffusion sheet of the present invention;

FIG. 2 is an enlarged perspective view that illustrates the diffusion sheet illustrated in FIG. 1 when viewed from below;

FIG. 3 is an enlarged perspective view that illustrates a modification of the diffusion sheet illustrated in FIG. 2;

FIG. 4 is a diagrammatic view that describes operation of the diffusion sheet illustrated in FIG. 1;

FIG. 5 is an enlarged perspective view that illustrates a modification of the diffusion sheet where minute projection sections are irregularly arranged;

FIG. 6 is a cross-sectional view that illustrates a diffusion sheet having a pad layer according to a second embodiment;

FIG. 7 is a diagrammatic view for describing operation of the diffusion sheet illustrated in FIG. 6;

FIG. 8 is a cross-sectional view that illustrates the diffusion sheet with a light-gathering layer containing transparent fine particles according to a second embodiment; and

FIG. 9 is a diagrammatic view that illustrates operation of the diffusion sheet illustrated in FIG. 8.

### DETAILED DESCRIPTION OF THE INVENTION

An exemplary embodiment of a diffusion sheet according to the present invention will be described hereunder by reference to the drawings.

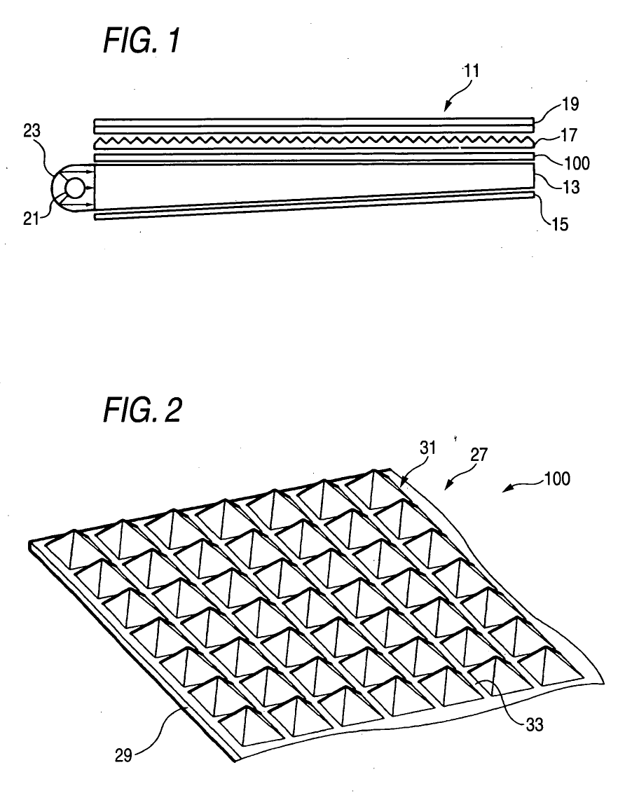

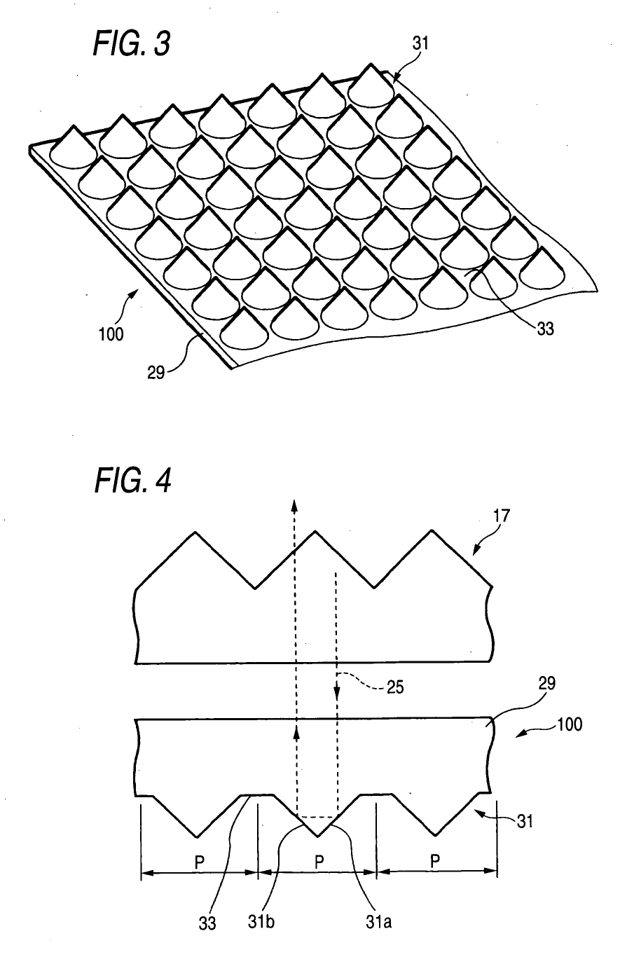

FIG. 1 is a side view of a characteristic portion of a backlight unit having a diffusion sheet of the present invention. FIG. 2 is an enlarged perspective view of the diffusion sheet illustrated in FIG. 1 when viewed from below. FIG. 3 is an enlarged perspective view of a modification of the diffusion sheet illustrated in FIG. 2. FIG. 4 is a diagrammatic view for describing action of the diffusion sheet illustrated in FIG. 1.

A diffusion sheet 100 of the present embodiment is provided on; e.g., a backlight unit 11 illustrated in FIG. 1. The backlight unit 11 comprises a reflection plate 15 provided on one surface (a back surface) of a light guide plate 13 made of transparent resin; the diffusion sheet 100 provided on the other surface (a front surface) of the light guide plate 13; a first prism sheet 17 and a second prism sheet 19 which are sequentially provided on a light exit side of the diffusion sheet 100; a light source 21 (e.g., a CCFL, an LED, or the like) disposed opposite the end face of one side of the light guide plate 13; and a reflector 23 for effectively reflecting the light from the light source 21 toward the light guide plate 13.

The backlight unit 11 has unillustrated flat display unit, such as a liquid-crystal display panel or the like, at the light exit side (the upper side in FIG. 1) of the second prism sheet 19, to thus constitute a flat display device. Specifically, the light emitted from the light source 21 passes through the diffusion sheet 100, the first prism sheet 17, and the second prism sheet 19; is converged after having undergone refraction and reflection; exits in a converged manner; and is supplied to the liquid-crystal display panel as backlight. The light reflected by the reflection sheet 15 also enters the light guide plate 13; passes through the diffusion sheet 100, the first prism sheet 17, and the second prism sheet 19; and is supplied to the liquid-crystal panel.

As mentioned above, the diffusion sheet 100 interposed between the light guide plate 13 and the first prism sheet 17 has light reflection unit 27 for re-reflecting feedback light 25—having returned, by reflection, from the first prism sheet 17—toward the first prism sheet 17. In the present embodiment, the light reflection unit 27 is formed from plural minute conical projection sections 31 which are illustrated in FIG. 2 and arranged on the surface of a translucent substrate 29, which is to become a base material, opposite the first prism sheet 17. Namely, the minute projection sections 31 protrude toward the light guide plate 13. In addition to assuming the shape of a square pyramid illustrated in FIG. 3 or the shape of a circular cone illustrated in FIG. 3, the minute conical projection sections 31 may assume the shape of a triangular pyramid or another pyramidal shape.

An average size of the minute projection sections 31 is preferably equal to or smaller than the size of pixels of a liquid-crystal display panel, those of a color filter, and the like Specifically, the minute projection sections 31 are preferably formed at a period of the order of p=5 to 500 μm or thereabouts.

The minute projection sections 31 are protrusively provided at intervals, and a space among the adjacent minute projection sections 31 forms a minute parallel flat surface 33 on both sides of the diffusion sheet 100. When the minute projection sections 31 are formed into a regular pyramid, the minute flat surface 33 may be omitted. The translucent substrate 29 and the minute projection sections 31 are formed from glass, plastic (polycarbonate, acrylic, or the like) or the like. A material having high transparency and rich flatness and moldability is preferable.

As illustrated in Fig. 4, the feedback light 25 having entered the translucent substrate 29 by way of the first prism sheet 17 propagates through the inside of the translucent substrate 29, whereupon the direction of the light is inverted by two nonparallel slopes 31a, 31b of the pyramidal minute projection section 31 formed on the side of the translucent substrate opposite the first prism sheet 17. The light then travels as if it returned toward the entrance, and is again emitted toward the first prism sheet 17 from the entrance side of the translucent substrate 29 where the light has first entered. Put another way, the diffusion sheet 100 operates so as to permit diffusion and passage of the incident light from the light guide plate 13 and return the light reflected by the first prism sheet 17 toward the first prism sheet 17 by means of retroreflection, In the present embodiment, the minute projection sections 31 are regularly arranged at regular intervals in the longitudinal and lateral directions. Thus, as a result of the minute projection sections 31 being regularly arranged, the action of the minute projection sections 31 for reflecting the feedback light 25 can comply with the respective pixels of, e.g., a display device. Effective improvements in an image, such as an increase in the brightness of the principal section (i.e., each of the pixel sections), and the like, can be achieved.

In the diffusion sheet having such a structure, when the light emitted from the light source 21 is supplied to the light guide plate 13 and the light exits from the light guide plate 13, the light enters and passes through the minute projection sections 31, and exits to the first prism sheet 17. Here, the portion of the light having exited from the diffusion sheet 100 and entered the first prism sheet 17 is returned to the diffusion sheet 100 as the feedback light 25. The propagating direction of the feedback light 25 is converted in essentially the opposite direction by means of the minute projection section 31, and the light is again emitted toward the first prism sheet 17. The feedback light 25, from the first prism sheet 17, which has hitherto been absorbed or become stray light is again returned toward (is caused to re-enter) the first prism sheet 17 upon reflection from the minute projection section 31. The loss of the feedback light 25, which is induced as a result of provision of the first prism sheet 17, is diminished.

Consequently, the diffusion sheet 100 is provided with the minute projection sections 31 for reflecting the feedback light 25, which has been returned from the first prism sheet 17 by means of reflection, again toward the first prism sheet 17. The feedback light 25, which has heretofore been absorbed or become stray light, from the first prism sheet 17 is returned toward (is again caused to enter) the first prism sheet 17 by means of reflecting action of the minute projection sections 31. The loss of the feedback light 25, which is induced as a result of provision of the first prism sheet 17, is diminished, whereby the utilization efficiency of light can be enhanced. Consequently, the front brightness can be made uniform and improved.

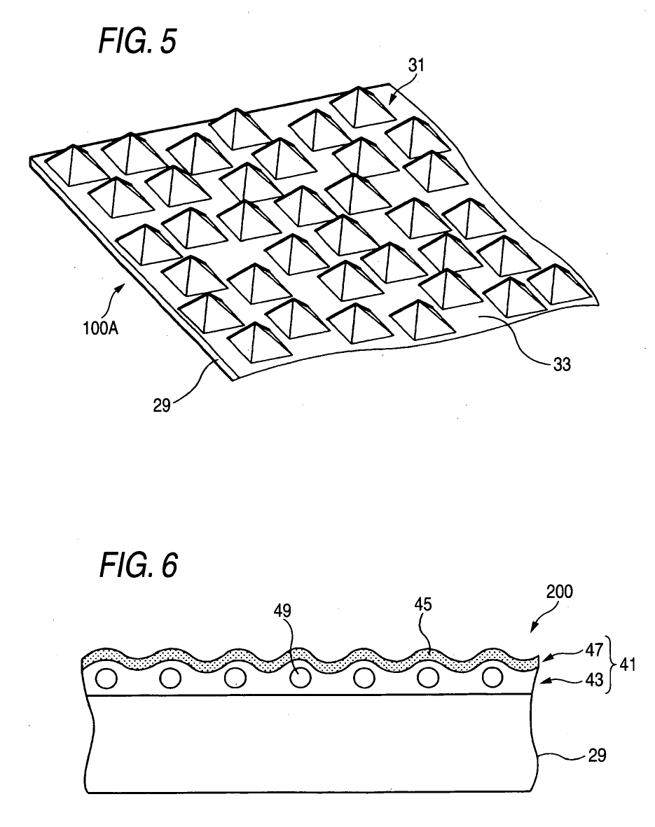

The diffusion sheet 100 of the above present embodiment has been described by means of taking as an example the configuration where the minute projection sections 31 are regularly provided. As illustrated in FIG. 5, the diffusion sheet of the present invention may be configured in such a way that the minute projection sections 31 are irregularly arranged at indefinite intervals and directions.

According to a diffusion sheet 100A adopting this irregular layout, the pixels of the display device and the minute projection sections 31 oppose each other at irregular relative positions, thereby preventing occurrence of moire, which would otherwise be caused when the pixels and the respective minute projection sections 31 are cyclically arranged so as to oppose each other.

A second embodiment of the diffusion sheet of the present invention will now be described.

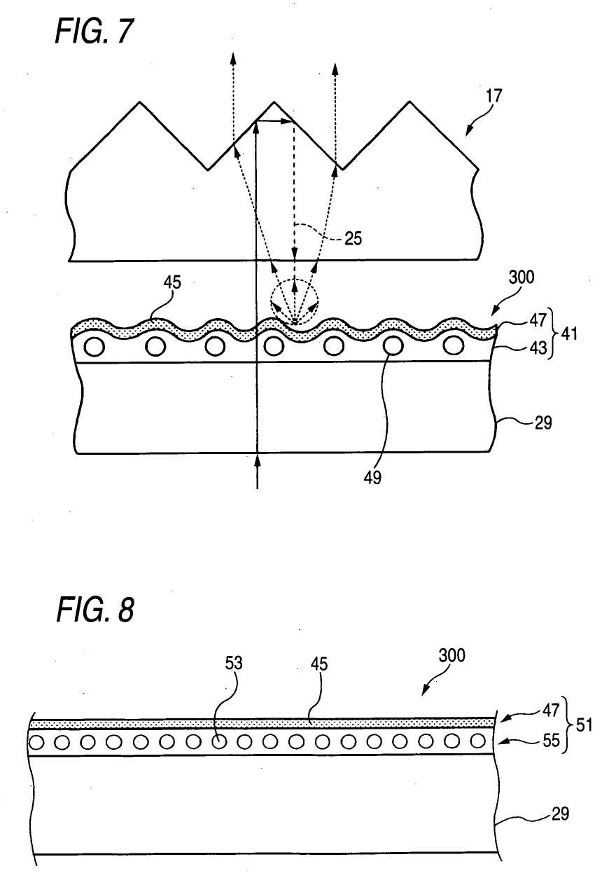

FIG. 6 is a cross-sectional view of a diffusion sheet having a pad layer according to a second embodiment. FIG. 7 is a schematic diagram for describing operation of the diffusion sheet illustrated in FIG. 6. In the following embodiment, those members and locations which are the same as those illustrated in FIGS. 1 through 4, are assigned the same reference numerals, and their repeated explanations are omitted.

In the diffusion sheet 200, light reflection unit 41 has a pad layer 43 having an irregular structure formed on the surface of the translucent substrate 29 for diffusing light; and a light transmissive reflection layer 47 which is formed along the irregular structure of the pad layer 43 and which includes light diffusion-and-reflection fine particles 45 at predetermined density.

The pad layer 43 is formed on one surface of the translucent substrate 29 opposing the first prism sheet 17. Pad formation fine particles 49 are spread over the surface of the translucent substrate 29, to thus apply a thin translucent film over the surface. Thereby, there is formed an irregular structure where projections are formed from the pad formation fine particles 49 and spaces between the pad formation fine particles 49 are formed into indentations. For instance, polymethylmethacrylate PMMA having high transparency is preferable as the pad formation fine particles 49. The light transmissive reflection layer 47 is formed to a predetermined thickness such that irregularities are left in the irregular surface. The light diffusion-and-reflection fine particles 45 are spread over the light transmissive reflection layer 47 at a predetermined density. For instance, white titanium fine particles can be used as the light diffusion-and-reflection fine particles 45.

The white titanium fine particles have high reflectance and do not permit transmission of light. Therefore, the light transmissive reflection layer 47 includes the white titanium fine particles at such appropriate density that transmission of outgoing light is permitted whilst the feedback light 25 from the first prism sheet 17 is reflected. The particle size of the white titanium fine particles preferably ranges from 0.1 μm to 1.0 μm, and preferably density of the white titanium fine particles ranges from 1 to 5 wt %.

As illustrated in FIG. 7, in the diffusion sheet 200, the incoming light from the light source 21 is diffused by the pad layer 43 and caused to travel toward the first prism sheet 17, whereas the feedback light 25 from the first prism sheet 17 undergoes diffusion and reflection on the light diffusion-and-reflection fine particles 45 of the light transmissive reflection layer 47 provided on the surface of the pad layer 43 and is again caused to exit toward the first prism sheet 17.

Consequently, the diffusion sheet 200 of the present embodiment has the light transmissive reflection layer 47 for again reflecting the feedback light 25, which has been returned upon reflection by the first prism sheet 17, toward the first prism sheet 17. The feedback light 25, from the first prism sheet 17, which has hitherto been absorbed or become stray light, is again returned toward (is caused to re-enter) the first prism sheet 17 by means of reflection on the light transmissive reflection layer 47, thereby diminishing a loss of the feedback light 25 induced as a result of provision of the first prism sheet 17 and enhancing utilization efficiency of light. Consequently, the front brightness can be made uniform and improved.

Next, there will be described a third embodiment of the diffusion sheet of the present invention.

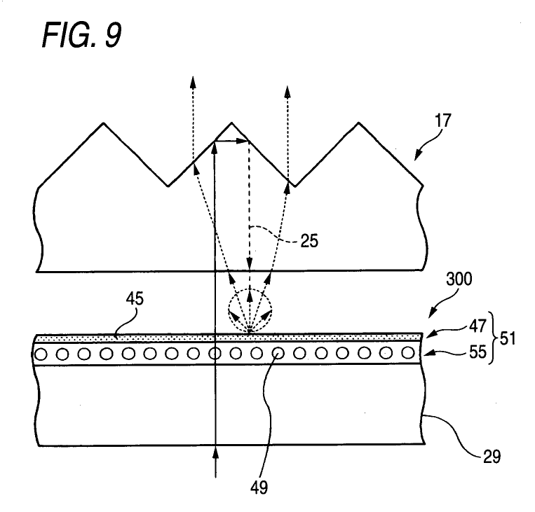

FIG. 8 is a cross-sectional view of the diffusion sheet of the second embodiment equipped with a light-gathering layer containing transparent fine particles; and FIG. 9 is a diagrammatic view for describing operation of the diffusion sheet illustrated in FIG. 8.

In the diffusion sheet 300, the light reflection unit 51 comprises a light-gather layer 55 which is formed on the surface of the translucent substrate 29 and contains transparent fine particles 53 for gathering transmitted light; and the light transmissive reflection layer 47 that is formed on the light exit surface of the light-gathering layer 55 and contains the light diffusion-and-reflection fine particles 45 at a predetermined density.

For instance, polymethylmethacrylate PMMA having high transparency is preferable as the transparent fine particles 53.

As illustrated in FIG. 9, in the diffusion sheet 300, the incident light from the light source 21 is collected and finely diffused by the light-gathering layer 55 and is caused to pass toward the first prism sheet 17. The feedback light 25 from the first prism sheet 17 undergoes diffusion and reflection on the light diffusion-and-reflection fine particles 45 of the light transmissive reflection layer 47 provided on the surface of the light-gathering layer 55, and the light is again caused to exit toward the first prism sheet 17.

Consequently, the diffusion sheet 300 of the present embodiment is provided with the light transmissive reflection layer 47 for again reflecting the feedback light 25, which has been returned upon reflection by the first prism sheet 17, toward the first prism sheet 17. Hence, the feedback light 25 from the first prism sheet 17, which has hitherto been absorbed or become stray light, is again returned toward (is caused to re-enter) the first prism sheet 17 by means of reflection on the light transmissive reflection layer 47, thereby diminishing a loss of the feedback light 25 induced as a result of provision of the first prism sheet 17 and enhancing utilization efficiency of light. Consequently, the front brightness can be made uniform and improved.

The present application claims foreign priority based on Japanese Patent Application (JP 2005-256477) filed September 5 of 2006, the contents of which is incorporated herein by reference.

What is claimed is:

1. A diffusion sheet interposed between a light guide plate and a prism sheet, comprising:
a light reflection unit reflecting a feedback light toward the prism sheet again, the feedback light being returned by the prism sheet.

2. The diffusion sheet according to claim 1,
wherein
the light reflection unit comprises:
a translucent substrate; and
a fine projection section arranged on a surface of the translucent substrate opposite the prism sheet, the fine projection section having a conical shape.

3. The diffusion sheet according to claim 2, wherein the fine projection section is regularly arranged at equal intervals in lateral and longitudinal directions.

4. The diffusion sheet according to claim 2, wherein the fine projection section is irregularly arranged at indefinite intervals and directions.

5. The diffusion sheet according to claim 2,
wherein
the light reflection unit comprises:
a pad layer having an irregular structure formed on a surface of the translucent substrate and diffusing light; and
a light transmissive reflection layer formed along the irregular structure of the pad layer and containing light diffusion-and-reflection fine particles.

6. The diffusion sheet according to claim 2,
wherein
the light reflection unit comprises:
a light-gathering layer formed on a surface of the translucent substrate and including transparent fine particles collecting a transmitted light; and
a light transmissive reflection layer formed on a light exit surface of the light-gathering layer and containing light diffusion-and-reflection fine particles.
